(19) United States
(12) Patent Application Publication
(10) Pub. No.: US 2026/0152997 A1
(43) Pub. Date: Jun. 4, 2026

(54) MULTIFUNCTIONAL ROLLER BLIND DEVICE

(71) Applicant: OXTI Pte Ltd, Singapore (SG)

(72) Inventor: YU-LIN LIN, Singapore (SG)

(21) Appl. No.: 18/969,227

(22) Filed: Dec. 4, 2024

(51) Int. Cl. E06B 9/42; E06B 9/68

(52) U.S. Cl. CPC E06B 9/42; E06B 9/68; E06B 2009/6818

(57) ABSTRACT

A multifunctional roller blind device includes a roller blind body, which includes a roller driven by a drive module and a covering connected to the covering; a control circuit, which is arranged in the roller blind body and electrically connected to the drive module; a sensor module, which is arranged on the roller blind body and electrically connected to the control circuit; and a sound generation module, which is arranged on the roller blind body. The sensor module detects the brightness in a room and sends out a sensing signal, based on which the control circuit controls the drive module to rotate the roller to roll up or lower down the covering, thereby fulfilling automatic control. The covering includes a sound insulation material to prevent outdoor noise from entering the room and the sound generation module is operable to generate sounding, so as to achieve the purpose of multiple functions.

### BACKGROUND OF THE INVENTION

### (a) Technical Field of the Invention

The present invention relates generally to a roller blind device, and more particularly to a multifunctional roller blind device.

### (b) Description of the Prior Art

A roller blind is a type of window covering that can be rolled up and down directly for storage.

Taiwan Utility Model M534238 discloses a roller blind device, which comprises a roller blind unit. A height adjustment assembly and a rolling assembly are respectively provided on two ends of the roller blind unit. The height adjustment assembly and the rolling assembly are each provided with a fixing assembly externally attached thereto in a detachable manner. The fixing assembly is made up of a fixing rack and an adjusting member. The adjusting member is detachably mounted on the fixing rack and extends into the height adjustment assembly or the rolling assembly corresponding thereto. The adjusting member includes a housing, an adjusting unit, and an adjusting rod, and the adjusting rod has an adjustment notch that is exposed through a side opening of the housing.

However, the known roller blind device has just one single function for covering and does not possess other functions, and thus has limited use and does not suit consumers'demand for multiple functions. Thus, it is desired to improve the known roller blind device in order to suit the needs of the modern people.

### SUMMARY OF THE INVENTION

To achieve the above objective, the present invention provides a multifunctional roller blind device, which comprises: a roller blind body, the roller blind body comprising a roller and a covering, the covering being connected to the roller, the roller being drivable by a drive module; a control circuit, the control circuit being arranged in the roller blind body and electrically connected to the drive module; a sensor module, the sensor module being arranged on the roller blind body and electrically connected to the control circuit; and a sound generation module, the sound generation module being arranged on the roller blind body.

In the above, the covering comprises a sound insulation material.

In the above, the sensor module comprises a photo sensor.

In the above, the roller blind body is provided with a signal receiver module, and the signal receiver module is electrically connected to the control circuit.

In the above, the sound generation module comprises a sound box, a loud speaker, or a buzzer.

The sensor module detects the brightness in a room, and the sensor module sends out a sensing signal, so that the control circuit controls the drive module according to the sensing signal to have the drive module drive the roller, so as to have the roller roll up or lower down the covering, thereby achieving the function of automatic control. The covering comprises a sound insulation material to prevent outdoor noise from entering the room through the covering and the sound generation module is operable to generate sounding, so that the purpose of multiple functions is achieved.

### BRIEF DESCRIPTION OF THE DRAWINGS

FIG. 1 is a perspective view showing a multifunctional roller blind device according to the present invention.

FIG. 2 is an exploded view showing the multifunctional roller blind device according to the present invention.

FIG. 3 is a block diagram of the multifunctional roller blind device according to the present invention.

FIG. 4 is a schematic view illustrating a covering is being rolled down according to the present invention.

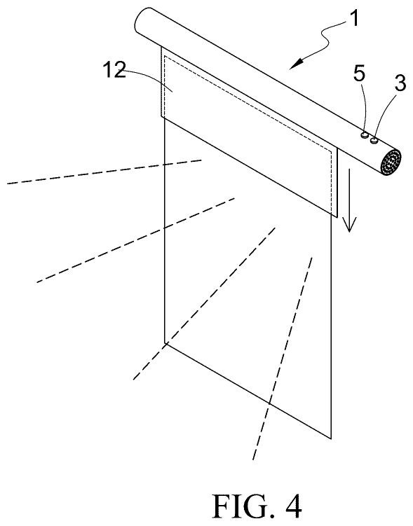

FIG. 5 is a schematic view illustrating the covering is being rolled up according to the present invention.

FIG. 6 is a schematic view illustrating a roller is being remotely controlled according to the present invention.

FIG. 7 is a schematic view illustrating a sound generation module is being remotely controlled according to the present invention.

### DETAILED DESCRIPTION OF THE PREFERRED EMBODIMENTS

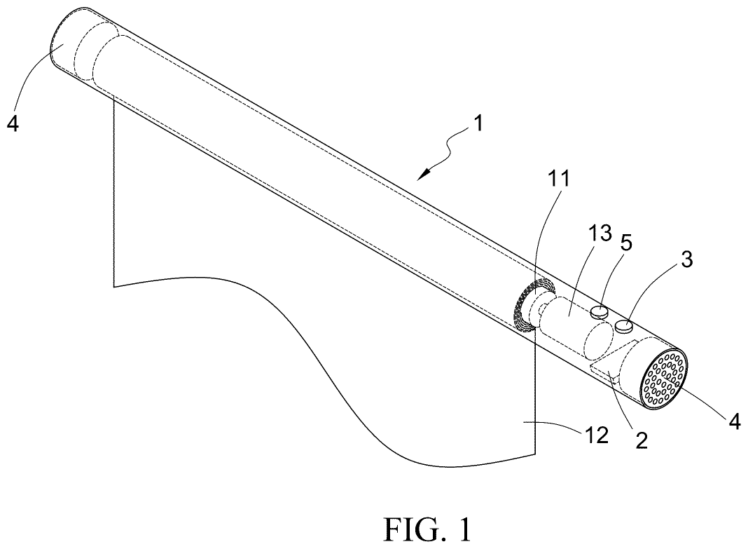

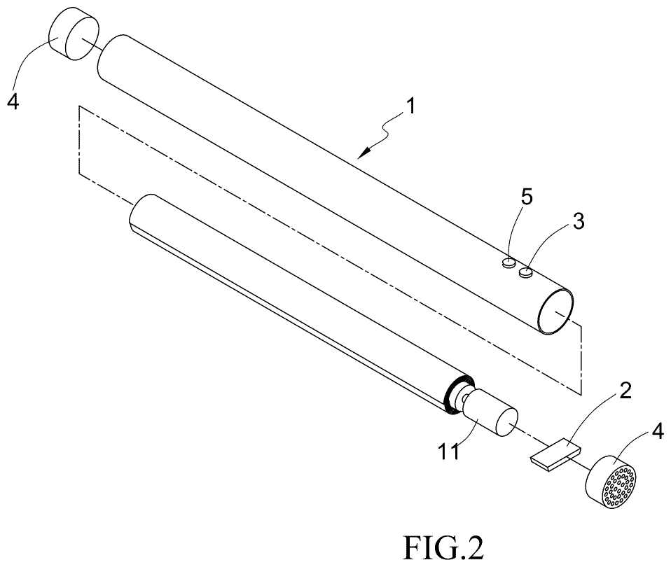

Referring to FIGS. 1, 2, and 3, the present invention provides a multifunctional roller blind device, which comprises:
a roller blind body 1, wherein the roller blind body 1 comprises a roller 11 and a covering 12, the covering 12 being connected to the roller 11, the roller 11 being driven by a drive module 13, wherein the drive module 13 can be a motor, and the motor has a spindle connected to the roller, and the motor is operable to drive the roller 11 to rotate to allow the roller 11 to roller up or down the covering 12; and the covering 12 comprises a sound insulation material, so that the sound insulation material can be used to reflect or absorb noises for blocking the noises outside of the covering 12, wherein the sound insulation material can be velvet, jacquard, or resin-coated fabric;
a control circuit 2, wherein the control circuit 2 is arranged in an interior of the roller blind body 1 and is electrically connected to the drive module 13, wherein the control circuit 2 comprises a motor control circuit (not shown), the motor the control circuit being operable to control forward rotation, backward rotation, or stop of the motor;
a sensor module 3, wherein the sensor module 3 is arranged on the roller blind body 1 and is electrically connected to the control circuit 2, wherein the sensor module 3 comprises a photo sensor, and the photo sensor can be a photo resistor, a photo transistor, a photodiode, or a light sensing integrated circuit (IC), and the sensor module 3 functions to sense environment brightness; and
a sound generation module 4, wherein the sound generation module 4 is arranged on the roller blind body 1, wherein the sound generation module 4 can be a soundbox, a loud speaker, or a buzzer.

In the above, the roller blind body 1 is provided with a signal receiver module 5, and the signal receiver module 5 is electrically connected to the control circuit 2. The signal receiver module 5 can be a wireless signal receiver module, which is operable to receive a wireless signal. The wireless signal receiver module can be a Bluetooth module or a Wi-Fi module, and the wireless signal can be a Bluetooth signal or a Wi-Fi signal. The wireless signal is received from a mobile device 7, and the mobile device 7 can be a mobile phone or a remote control.

The control circuit 2 is electrically connected to a power supply 6. The power supply 6 is operable to supply electrical power. The power supply 6 is generally an external power supply, and the external power supply can be an indoor alternate-current power source (where the alternate-current power source is usable by plugging a power cord into a wall socket).

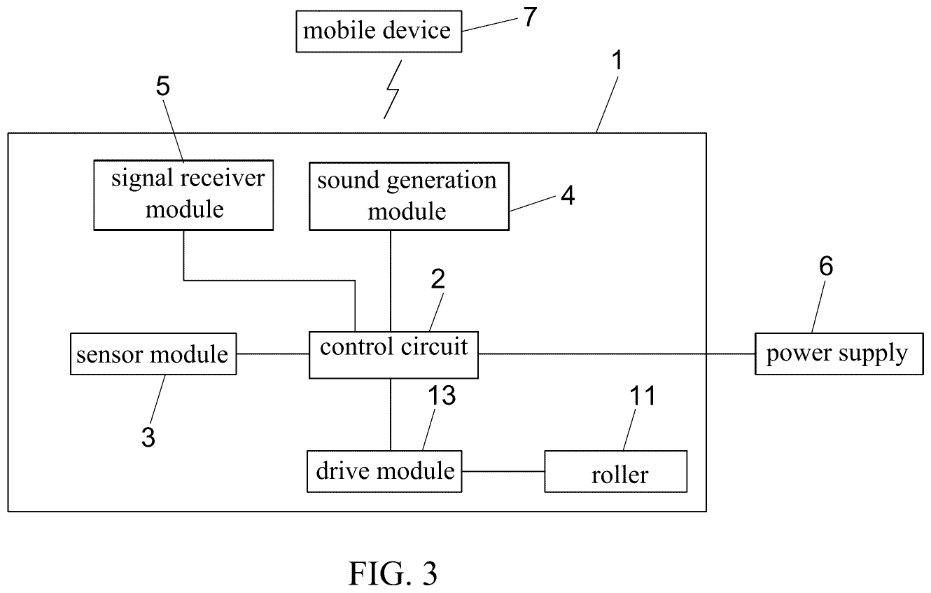

Referring to FIGS. 1, 3 and, 4, when the power supply 6 is activated, the sensor module 3 detects the brightness in the room, and if sun shines into the room, the sensor module 3 sends out a sensing signal to the signal receiver module 5 of the roller blind body 1, and the control circuit 2 controls the drive module 13 according to the sensing signal, such that the drive module 13 drives the roller 11 to rotate to have the roller 11 lower down the covering 12 to block sunlight.

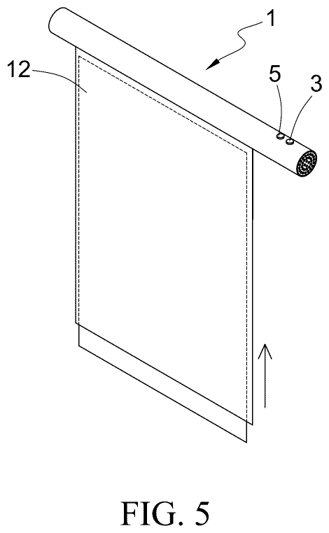

Referring to FIGS. 1, 3, and 5, when the power supply 6 is activated, the sensor module 3 detects the brightness in the room, and if sunlight does not shine into the room, the sensor module 3 sends out a sensing signal to the signal receiver module 5 of the roller blind body 1, and the control circuit 2 controls the drive module 13 according to the sensing signal, such that the drive module 13 drives the roller 11 to rotate to have the roller 11 rolls up the covering 12 to thereby achieve a function of automatic control.

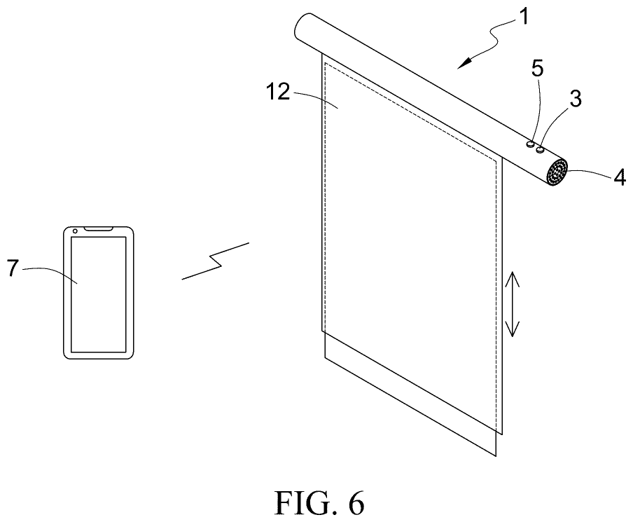

Referring to FIGS. 1, 3, and 6, when the power supply 6 is activated, the mobile device 7 can be operated to remotely control the roller 11, meaning the mobile device 7 sends out a wireless signal to the signal receiver module 5 of the roller blind body 1, and the control circuit 2 controls the drive module 13 according to the wireless signal, such that the drive module 13 drives the roller 11 to rotate to have the roller 11 roll up or lower down the covering 12.

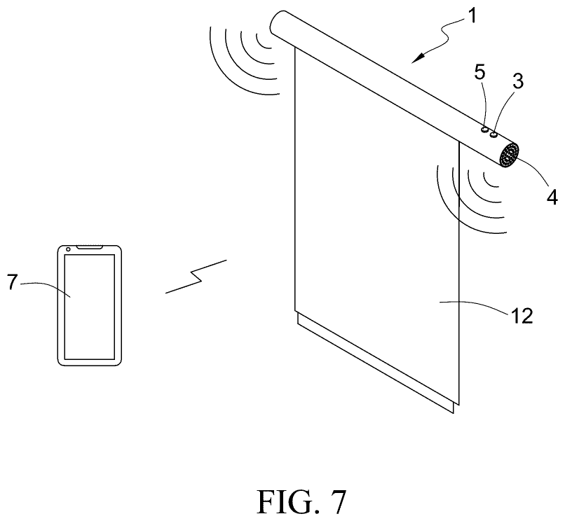

Referring to FIGS. 1, 3, and 7, when the power supply 6 is activated, the mobile device 7 can be operated to remotely control the sound generation module 4, meaning the mobile device 7 sends out a wireless signal to the signal receiver module 5 of the roller blind body 1, and the control circuit 2 controls the sound generation module 4 to generate sounding or stop sounding according to the wireless signal.

The present invention uses the sensor module 3 to detect the brightness in the room, and the sensor module 3 sends out a sensing signal. The control circuit 2 controls the drive module 13 according to the sensing signal, so that the drive module 13 drives the roller 11 to have the roller 11 to roll up or lower down the covering 12 thereby achieving the function of automatic control. The covering 12 comprises a sound insulation material to prevent outdoor noise from entering the room through the covering 12 and the sound generation module 4 is operable to generate sounding, so that the purpose of multiple functions is achieved.

I claim:

1. A multifunctional roller blind device, comprising:
a roller blind body, wherein the roller blind body comprises a roller and a covering, the covering being connected to the roller, the roller being drivable by a drive module;
a control circuit, wherein the control circuit is arranged in the roller blind body and is electrically connected to the drive module;
a sensor module, wherein the sensor module is arranged on the roller blind body and is electrically connected to the control circuit; and
a sound generation module, wherein the sound generation module is arranged on the roller blind body.

2. The multifunctional roller blind device according to claim 1, wherein the covering comprises a sound insulation material.

3. The multifunctional roller blind device according to claim 1, wherein the sensor module comprises a photo sensor.

4. The multifunctional roller blind device according to claim 1, wherein the roller blind body is provided with a signal receiver module, and the signal receiver module is electrically connected to the control circuit.

5. The multifunctional roller blind device according to claim 1, wherein the sound generation module comprises a sound box, a loud speaker, or a buzzer.
